(19) United States
(12) Patent Application Publication
(10) Pub. No.: US 2011/0143307 A1
(43) Pub. Date: Jun. 16, 2011

(54) STENT, A REPRODUCING METHOD USING THE STENT, AND A METHOD FOR POSITIONING A WIRE

(76) Inventor: Akira Takebayashi, Saitama (JP)

(21) Appl. No.: 12/922,920

(22) PCT Filed: Mar. 24, 2009
(86) PCT No.: PCT/JP2009/055874

§ 371 Date: Jan. 11, 2011

(30) Foreign Application Priority Data
Mar. 27, 2008 (JP) 2008-084005

(51) Int. Cl. A61C 13/36

(52) U.S. Cl. 433/74

(57) ABSTRACT

Provided is a stent used when a wire that indicates the position and orientation a fixture is to be embedded at on a mockup for creating an anatomically and prosthetically appropriate and highly accurate surgical guide.

The stent includes a detachably attachable guide member 1 that includes a fitting portion 2 to be fitted to a tooth portion of the mockup and an actual tooth portion of a patient corresponding to the tooth portion of the mockup, and a covering portion 3 covering a mucosa surface 44 at the portion a tooth is missing; a first positioning member 10 including at least a planar first contrast medium 11 for CT scanner and mounted to the covering portion 3; and a second positioning member 20 including at least a planar second contrast medium 21, the member 20 opposing to the first contrast medium 11 and detachably attachable to the member 10.

### TECHNICAL FIELD

The present invention relates to a stent used for positioning a wire that indicates the position and orientation a dental implant fixture is to be embedded at when the wire is embedded in an upper jaw mockup or a lower jaw mockup, in which the mockup imitates inside of the mouth of a patient; and a reproducing method and a method for positioning the wire using the stent.

### BACKGROUND

A dental implant (hereinafter simply referred to “implant”) used for implant treatment is made up of a fixture (implant body, for example, made of titanium) to be embedded into an alveolar bone at which a tooth is missing, an abutment coupled to and supporting the fixture, and a superstructure (artificial tooth crown) attached to the abutment (see JP-A-2001-170080, for example). In the implant treatment that uses this type of implant, it is important firstly that the position and orientation of the fixture to be embedded at should be determined at a position and an orientation that are anatomically and prosthetically appropriate for the fixture to be embedded at; and secondly that a hole into which the fixture is to be embedded should be accurately formed in the mouth of a patient at the appropriate position and orientation by using a drill.

In an example of a method for determining the position and orientation the fixture is to be embedded at, mockups (plaster models) of the upper and the lower jaws of a patient are mounted to an articulator, and a position and orientation that are prosthetically appropriate for the fixture to be embedded at are obtained from the mockups. The obtained position and orientation are displayed on a CT scanner display using a contrast medium. Then the position and orientation at which the fixture should be embedded are determined by simulation on the display, in consideration of the obtained position and orientation, and also the internal structure (anatomical shape) of the jaw bone of the patient.

As a method for accurately forming a hole by a drill, various surgical guides have been devised.

### SUMMARY

In the above-mentioned method for determining the position and orientation that are anatomically and prosthetically appropriate for the fixture to be embedded at, the fixture is not always embedded into the prosthetically appropriate position and orientation, depending on the anatomical shape of the jawbone of the patient. Therefore, in many cases, a need arises to make modifications to the prosthetically appropriate position and orientation in the simulation, in consideration of the internal structure (anatomical shape) of the jaw bone. However, in order to analyze whether the position and orientation modified by the simulation are still prosthetically appropriate or not, it is required that the position and orientation should be reproduced on the mockup. If necessary, it is also required that the mockups should be mounted back to the articulator in order to three-dimensionally comprehend the occlusal relation with the dental antagonist or mesiodistal and buccolingual position and orientation for further analysis. As a result of the analysis, in some cases, the position and orientation that are anatomically and also prosthetically appropriate for the fixture to be embedded at can be determined only after the simulation is modified again and cut-and-try processes are repeated.

However, the method for reproducing on the CT scanner display the position and orientation of embedding hole on the mockup, and contrary, the method for reproducing on the mockup the position and orientation of the embedding hole on the CT scanner display have not yet been devised. Therefore, the position and orientation the fixture is to be embedded at are currently determined only by simulation software, and a surgical guide is created based on the simulation. In simulation software, it is impossible to three-dimensionally comprehend the occlusal relation with the dental antagonist or mesiodistal and buccolingual position and orientation even if three-dimensional simulation software is used, and thus it is difficult to analyze the prosthetic appropriateness.

Therefore, an aim of the present invention is to provide a stent which is capable of reproducing on a CT scanner display readily and highly accurately the position and orientation of a fixture to be embedded at on a mockup, and contrary, reproducing on the mockup readily and highly accurately the position and orientation of the fixture to be embedded at on the CT scanner display; a reproducing method using the stent; and a method for positioning a wire, embedded in the mockup and indicating the position and orientation of the fixture to be embedded at, for creating a surgical guide.

### Means to Solve the Problems

The invention according to claim 1 relates to a stent used for positioning a wire that indicates the position and orientation a dental implant fixture is to be embedded at when the wire is embedded in an upper jaw mockup or a lower jaw mockup, in which the mockup imitates inside of the mouth of a patient. The stent according to the invention is characterized in that the stent includes a detachably attachable guide member that includes a fitting portion to be fitted to a tooth portion of the mockup and to an actual tooth portion of the patient that corresponds to the tooth portion of the mockup, and a covering portion that covers a mucosa surface at a portion a tooth is missing; a first positioning member including at least a planar first contrast medium for a CT scanner and mounted to the covering portion; and a second positioning member including at least a planar second contrast medium for the CT scanner, the second positioning member opposing to the first contrast medium and being detachably attachable to the first positioning member.

The invention according to claim 2 is characterized in that the first contrast medium and the second contrast medium are disposed in substantially parallel to each other in the stent according to claim 1.

The invention according to claim 3 is characterized in that the stent according to claim 1 includes first positioning references formed by removing a portion of the first contrast medium, and second positioning references formed by removing a portion of the second contrast medium.

The invention according to claim 4 is characterized in that the second positioning member in the stent according to claim 3 has two pole-like spacers embedded therein facing toward the first positioning member, and the first positioning member has engaging holes with which the tip of the spacers are engaged, and the second positioning references are formed at portions corresponding to base end portions of the two spacers, and the first positioning references are formed at portions corresponding to the engaging holes.

The invention according to claim 5 is characterized in that a planar third contrast medium is provided in the covering portion of the guide member at a portion that contacts the mucosa surface.

The invention according to claim 6 is characterized in that the stent according to claim 2 includes a planar reference plate for positioning a CT scanner, the reference plate being mounted to the guide member in substantially parallel to the first contrast medium and the second contrast medium, and protruding outward from the mouth of the patient when the guide member is fitted to the tooth portion of the patient.

The invention according to claim 7 is characterized in that an X-ray absorber is provided in the fitting portion of the guide member or on a surface of the fitting portion, in the stent according to claim 1.

The invention according to claim 8 is characterized in that grid-like scales are provided to the first contrast medium and the second contrast medium, and the contrast medium at the portions of the scales is removed, in the stent according to claim 1.

The invention according to claim 9 is characterized in that a multiple of small holes are provided in a grid-like pattern to the first contrast medium and the second contrast medium, and the contrast medium at the portions of the small holes is removed, in the stent according to claim 1.

The invention according to claim 10 relates to a method for reproducing on a CT scanner display the position and orientation of a fixture to be embedded at on a mockup that imitates inside of the mouth of a patient. The method uses a stent that includes a detachably attachable guide member that includes a fitting portion to be fitted to a tooth portion of the mockup and to an actual tooth portion of the patient that corresponds to the tooth portion of the mockup, and a covering portion that covers a mucosa surface at a portion a tooth is missing; a first positioning member including at least a planar first contrast medium for a CT scanner and mounted to the covering portion; and a second positioning member including at least a planar second contrast medium for the CT scanner, the second positioning member opposing to the first contrast medium and being detachably attachable to the first positioning member.

The reproducing method according to the invention is characterized in that the method including:

(1) a wax-up hole forming step in which an upper jaw mockup and a lower jaw mockup are mounted to an articulator, and wax-up for the missing tooth is performed on the mucosa surface of the mockup, and a first through-hole is formed at the position and orientation the fixture should be embedded, in the tooth for which wax-up is performed,

(2) an irradiating step for irradiating the center of the first through-hole by a light beam from a pointer movably supported by a supporting member, a base end portion of the supporting member being mounted to the mockup,

(3) a positioning reference forming step for forming first positioning references by removing a portion of the first contrast medium, and forming second positioning references by removing a portion of the second contrast medium,

(4) a second positioning step in which the tooth for which wax-up is performed is removed from the mockup, and the stent is mounted to the mockup, and a second removed portion is formed by removing a portion, which is irradiated by the light beam, of the second contrast medium in the second positioning member of the stent,

(5) a first positioning step for forming a first removed portion by removing a portion, which is irradiated by the light beam, of the first contrast medium in the first positioning member,

(6) an imaging step in which the stent is removed from the mockup, and the stent is fitted to the tooth portion of the patient and CT scanning is performed, and

(7) a simulation step for simulating on the CT scanner display a virtual embedding hole of the fixture, along an extended line of a straight line that connects the first removed portion and the second removed portion.

The invention according to claim 11 relates to a method for reproducing on a mockup the position and orientation of a fixture to be embedded at on a CT scanner display, in which the mockup imitates inside of the mouth of a patient. The method uses a stent that includes a detachably attachable guide member that includes a fitting portion to be fitted to a tooth portion of the mockup and to an actual tooth portion of the patient that corresponds to the tooth portion of the mockup, and a covering portion that covers a mucosa surface at a portion a tooth is missing; a first positioning member including at least a planar first contrast medium for a CT scanner and mounted to the covering portion; and a second positioning member including at least a planar second contrast medium for the CT scanner, the second positioning member opposing to the first contrast medium and being detachably attachable to the first positioning member.

The reproducing method according to the invention is characterized in that the method includes:

(8) a modifying step for modifying a virtual embedding hole on the CT scanner display, based on the internal structure of the jaw bone of the patient,

(9) an intersection point determining step for obtaining a first intersection point and a second intersection point on the display, the first and second intersection points being the points at which the center line of the modified virtual embedding hole of the fixture intersects the first contrast medium and the second contrast medium,

(10) a coordinate reading step for reading on the display the coordinate of the first intersection point with respect to the first positioning references and the coordinate of the second intersection point with respect to the second positioning references,

(11) a drawing step for drawing the first intersection point and the second intersection point onto the first contrast medium and the second contrast medium of the stent, based on the read coordinates,

(12) a marking step for putting a mark at the first intersection point drawn on the first contrast medium,

(13) a second through-hole forming step for forming a second through-hole at the second intersection point drawn on the second contrast medium, and

(14) a pointer positioning step in which the stent is mounted to the mockup, and a pointer is fixed to the mounted stent at a position such that the light beam from the pointer, which passes through the second through-hole, irradiates the mark.

The invention according to claim 12 relates to a positioning method for positioning a wire that indicates the position and orientation a dental implant fixture is to be embedded at when the wire is embedded in a mockup that imitates inside of the mouth of a patient. The method uses a stent that includes a detachably attachable guide member that has a fitting portion to be fitted to a tooth portion of the mockup and to an actual tooth portion of the patient that corresponds to the tooth portion of the mockup, and a covering portion that covers a mucosa surface at a portion a tooth is missing; a first positioning member including at least a planar first contrast medium for a CT scanner and mounted to the covering portion; and a second positioning member including at least a planar second contrast medium for the CT scanner, the second positioning member opposing to the first contrast medium and being detachably attachable to the first positioning member.

The positioning method according to the invention is characterized in that the method includes:

(1) a wax-up hole forming step in which an upper jaw mockup and a lower jaw mockup are mounted to an articulator, and wax-up for the missing tooth is performed on the mucosa surface of the mockup, and a first through-hole is formed at the position and orientation the fixture should be embedded, in the tooth for which wax-up is performed,

(2) an irradiating step for irradiating the center of the first through-hole by a light beam from a pointer movably supported by a supporting member, a base end portion of the supporting member being mounted to the mockup,

(3) a positioning reference forming step for forming first positioning references by removing a portion of the first contrast medium, and forming second positioning references by removing a portion of the second contrast medium,

(4) a second positioning step in which the tooth for which wax-up is performed is removed from the mockup, and the stent is mounted to the mockup, and a second removed portion is formed by removing a portion, which is irradiated by the light beam, of the second contrast medium in the second positioning member of the stent,

(5) a first positioning step for forming a first removed portion by removing a portion, which is irradiated by the light beam, of the first contrast medium in the first positioning member,

(6) an imaging step in which the stent is removed from the mockup, and the stent is fitted to the tooth portion of the patient and CT scanning is performed,

(7) a simulation step for simulating on the CT scanner display a virtual embedding hole of the fixture, along an extended line of a straight line that connects the first removed portion and the second removed portion,

(8) a modifying step for modifying the virtual embedding hole on the CT scanner display, based on the internal structure of the jaw bone of the patient,

(9) an intersection point determining step for obtaining a first intersection point and a second intersection point on the display, the first and second intersection points being the points at which the center line of the modified virtual embedding hole of the fixture intersects the first contrast medium and the second contrast medium,

(10) a coordinate reading step for reading on the display the coordinate of the first intersection point with respect to the first positioning references and the coordinate of the second intersection point with respect to the second positioning references,

(11) a drawing step for drawing the first intersection point and the second intersection point onto the first contrast medium and the second contrast medium of the stent, based on the read coordinates,

(12) a marking step for putting a mark at the first intersection point drawn on the first contrast medium,

(13) a second through-hole forming step for forming a second through-hole at the second intersection point drawn on the second contrast medium,

(14) a pointer positioning step in which the stent is mounted to the mockup, and a pointer is fixed to the mounted stent at a position such that the light beam from the pointer, which passes through the second through-hole, irradiates the mark,

(15) an embedding hole forming step in which the stent is removed, and an embedding hole is formed in the mockup, along the light beam from the pointer, and

(16) an embedding step in which a wire is embedded in the embedding hole.

### Effect of the Invention

The position and orientation of the fixture to be embedded at on a mockup can be reproduced on a CT scanner display readily and with high accuracy, by using the stent according to any of claims 1 to 6, and adopting the reproducing method according to claim 10.

The position and orientation of the fixture to be embedded at on a CT scanner display can be reproduced on a mockup readily and with high accuracy, by using the stent according to any of claims 1 to 6, and adopting the reproducing method according to claim 11.

The wire that indicates the position and orientation a fixture is to be embedded at can be embedded in a mockup readily and with high accuracy, by using the stent according to any of claims 1 to 6, and adopting the positioning method according to claim 12.

A CT image with minimum halation can be obtained by using the stent according to claim 7.

By using the stent according to claim 8 or 9, the step (3) of claim 10, the step (11) of claim 11, and the steps (3) and (11) of claim 12 can be omitted, and the step (10) of claim 11 and the step (10) of claim 12 can be simplified.

### BRIEF DESCRIPTION OF THE DRAWINGS

FIG. 1 is a perspective view illustrating a configuration a stent S for the lower jaw.

FIG. 2 is a side view of the stent S.

FIG. 3 is a perspective view illustrating a condition in which a second positioning member 20 is disengaged from a first positioning member 10.

FIG. 4 illustrates steps of a method for positioning a wire W.

FIG. 5 illustrates a wax-up hole forming step S1.

FIG. 6 illustrates a wax-up hole forming step S1.

FIG. 7 illustrates a wax-up hole forming step S1.

FIG. 8 illustrates an irradiating step S2.

FIG. 9 illustrates a second positioning step S4 and a first positioning step S5.

FIG. 10 illustrates a simulation step S6.

FIG. 11 is a view as seen from a direction of the arrow A in FIG. 10.

FIG. 12A illustrates a modifying step S8 and an intersection point determining step S9.

FIG. 12B illustrates a coordinate reading step S10.

FIG. 12C illustrates a drawing step S11, a marking step S12, and a second through-hole forming step S13.

FIG. 13 illustrates a pointer positioning step S14.

FIG. 14 illustrates an embedding hole forming step S15.

FIG. 15 illustrates an embedding step S16.

FIG. 16 illustrates an implant 70.

FIG. 17 is a flowchart illustrating a method for positioning the wire W.

FIG. 18 is a side view of a pointer 52 and a mockup 41 mounted to a surveyor 80.

FIG. 19 is enlarged views for illustrating the coordinate reading step S10 using a first positioning member 10 and a second positioning member 20 on both of which scales are marked.

FIG. 20 illustrates a case where an embedding hole 54 is directly formed in the mockup 41.

FIG. 21 is an enlarged view of a tooth 45 for which wax-up is performed.

FIG. 22 illustrates cut-and-try.

### DETAILED DESCRIPTION OF THE PREFERRED EMBODIMENTS

Preferred embodiments of the present invention are described in detail with reference to the drawings. Same references are used throughout the drawings to designate like or equivalent configuration, and duplicated description thereof is omitted as appropriate. In addition, components that are not essential for explanation are omitted in the drawings as appropriate.

### Embodiment 1

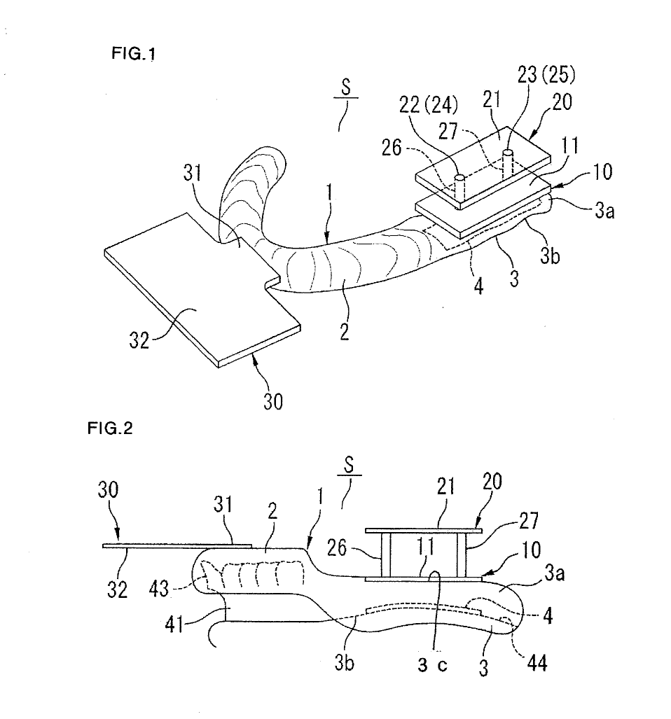

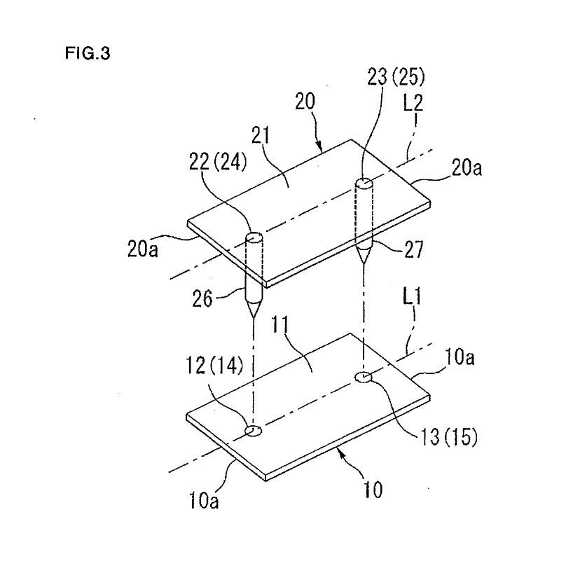

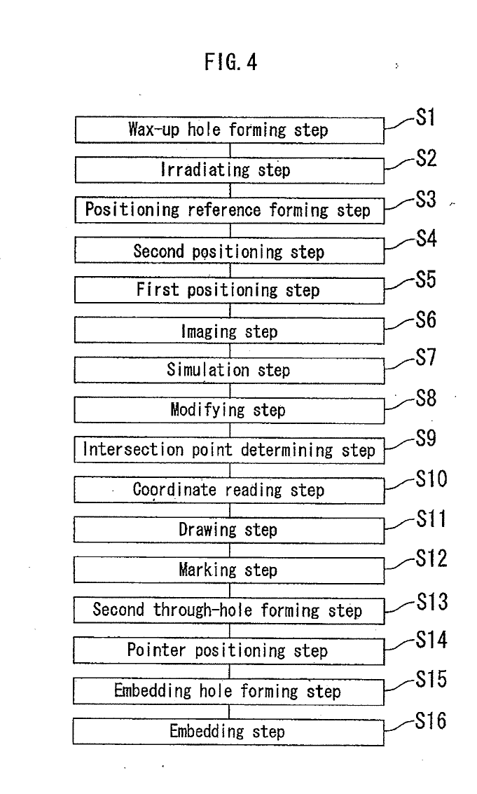

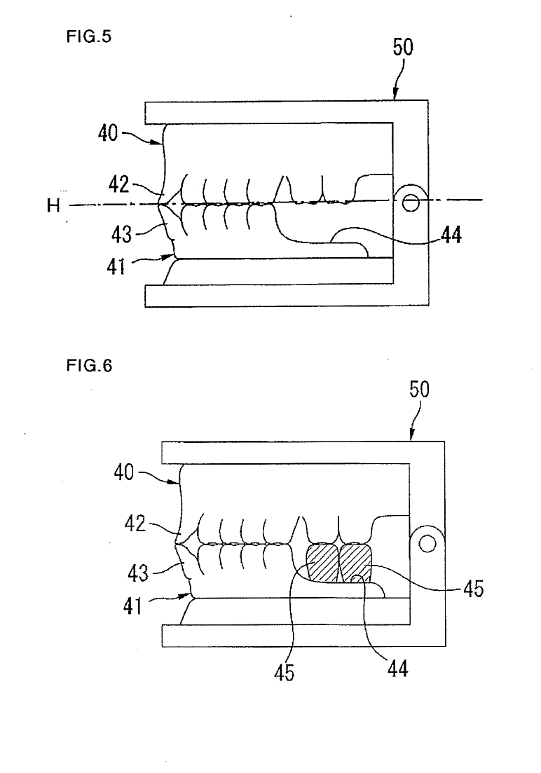

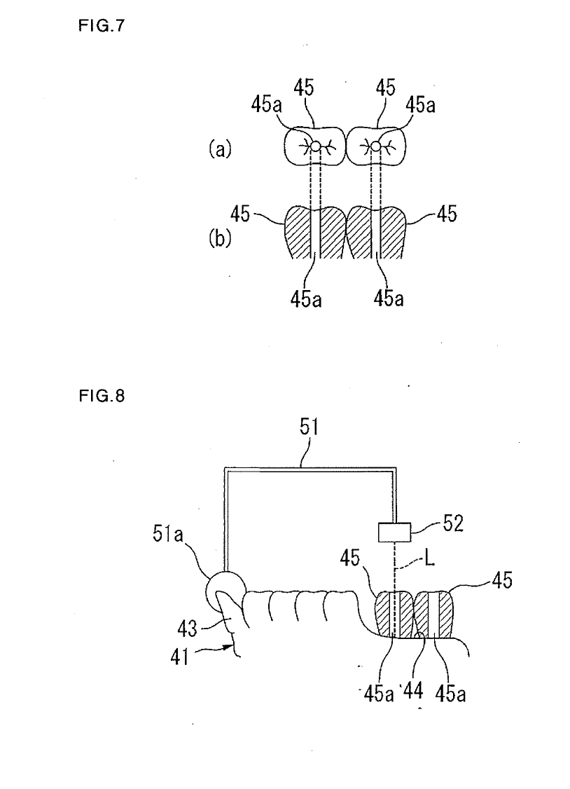

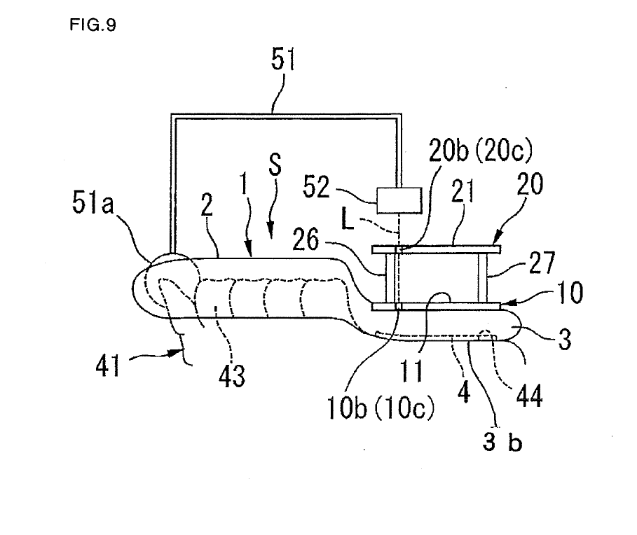

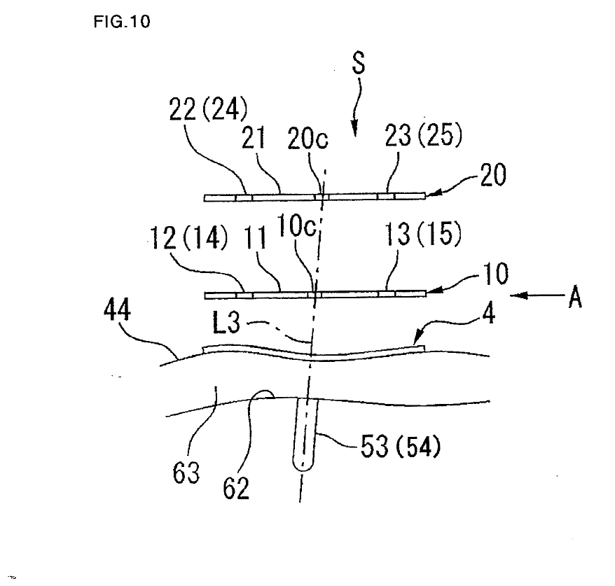

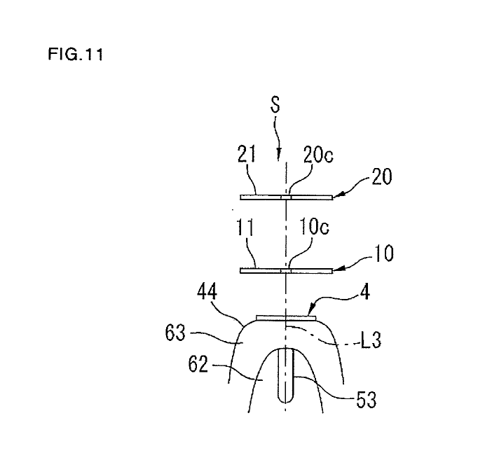

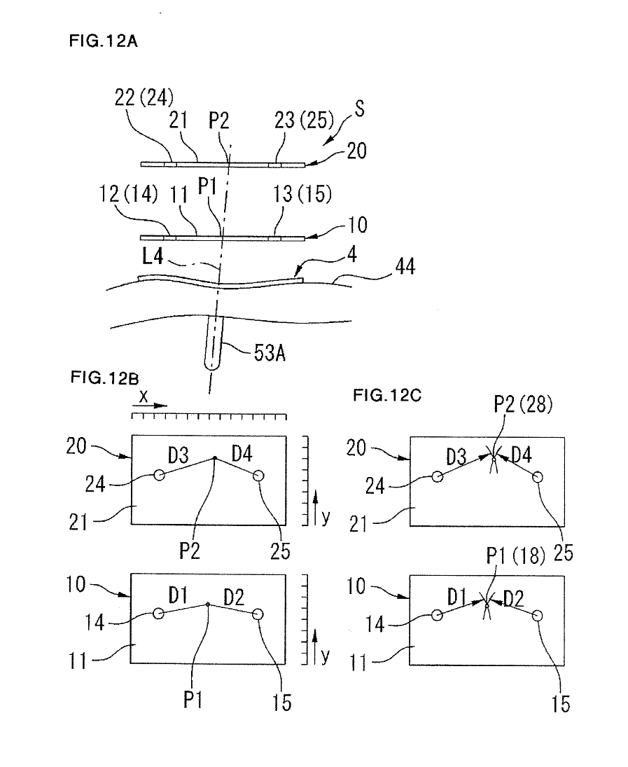

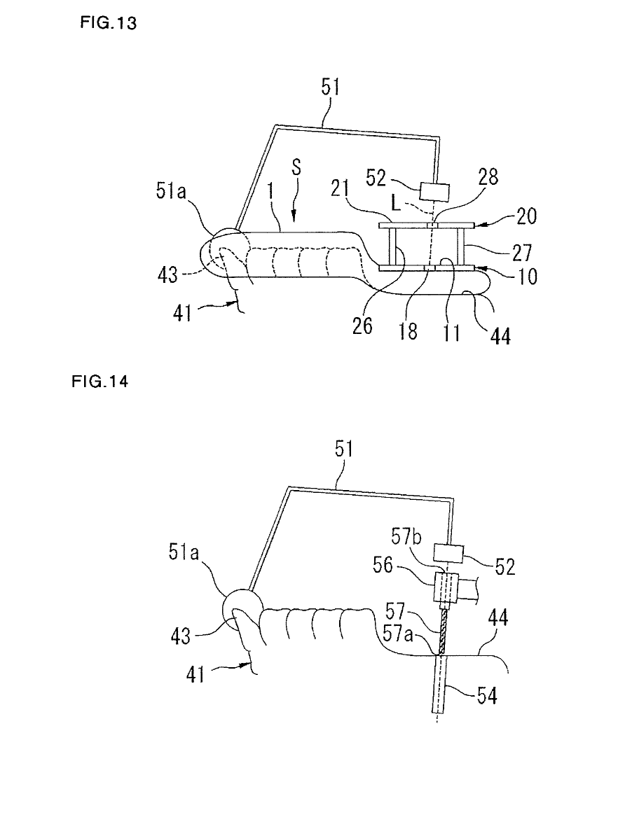

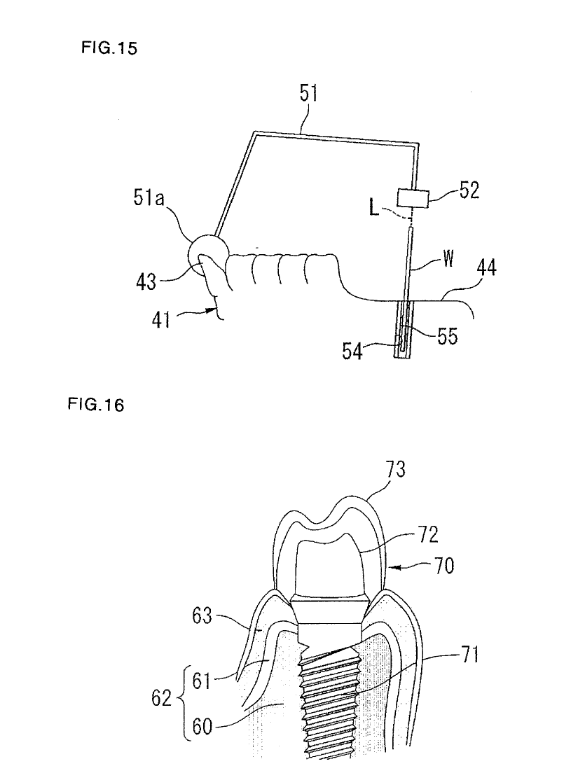

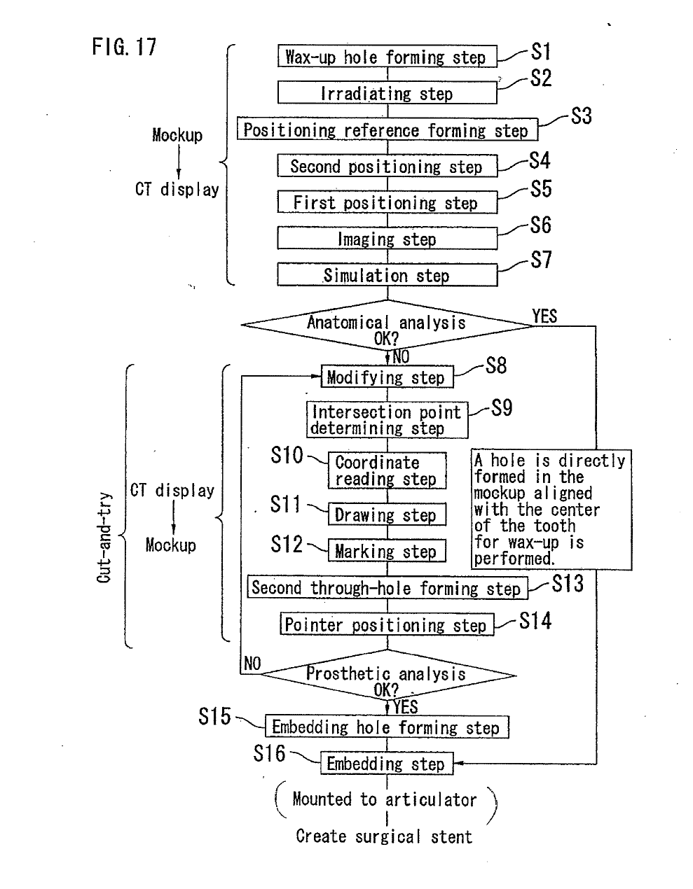

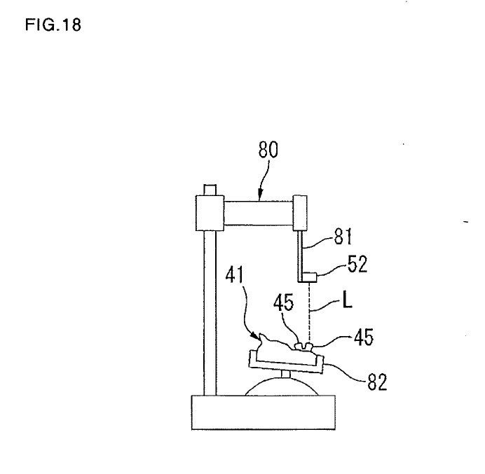

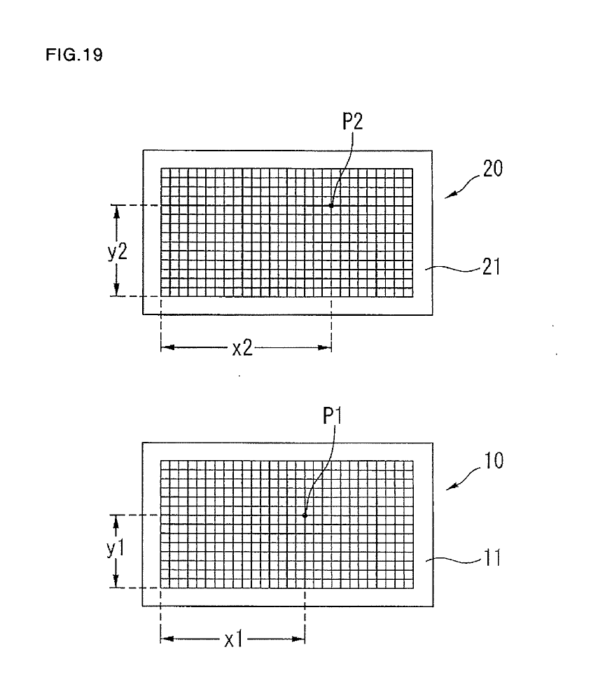

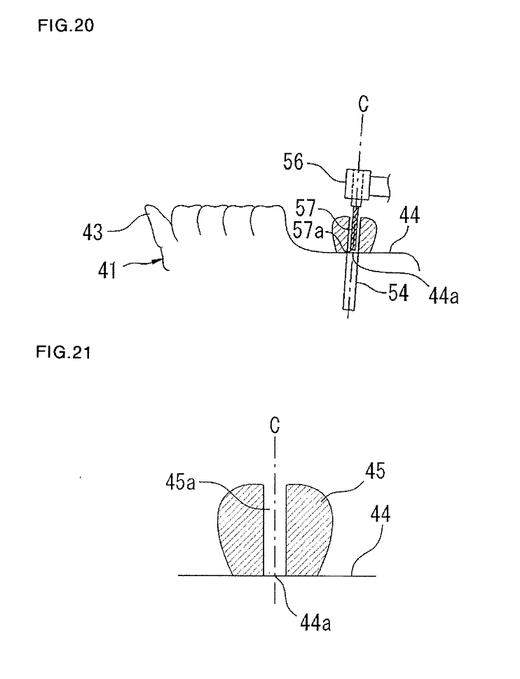

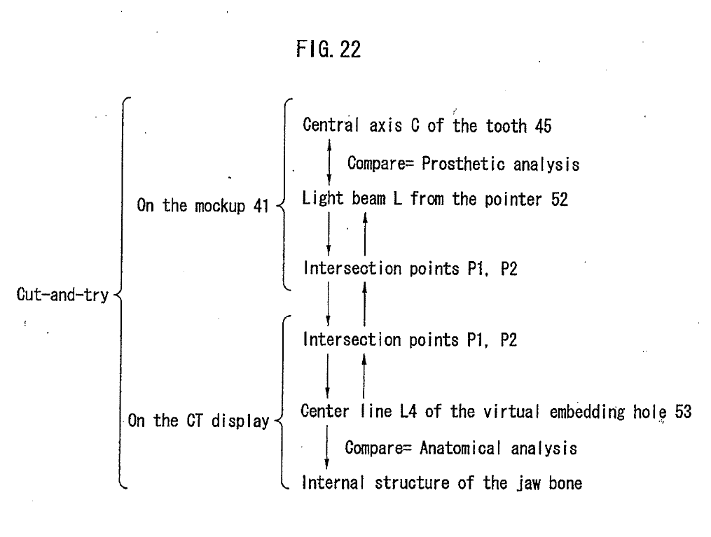

A stent S and a positioning method according to the present invention are described with reference to FIGS. 1 to 21. FIG. 1 is a perspective view for illustrating a configuration of the stent S. FIG. 2 is a side view of the stent S. FIG. 3 is a perspective view for illustrating a condition in which a second positioning member 20 is disengaged from a first positioning member 10. FIG. 4 illustrates steps of a method for positioning a wire W. FIG. 5, FIG. 6, and FIG. 7 illustrate a wax-up hole forming step S1. FIG. 8 illustrates an irradiating step S2. FIG. 9 illustrates a second positioning step S4 and a first positioning step S5. FIG. 10 illustrates a simulation step S7. FIG. 11 is a view as seen from a direction of the arrow A in FIG. 10. FIG. 12A illustrates a modifying step S8 and an intersection point determining step S9. FIG. 12B illustrates a coordinate reading step S10. FIG. 12C illustrates a drawing step S11, a marking step S12, and a second through-hole forming step S13. FIG. 13 illustrates a pointer positioning step S14. FIG. 14 illustrates an embedding hole forming step S15. FIG. 15 illustrates an embedding step S16. FIG. 16 illustrates an implant 70. FIG. 17 is a flowchart illustrating a method for positioning the wire W. FIG. 18 is a side view of a pointer 52 and a mockup 41 mounted to a surveyor 80. FIG. 19 is enlarged views for illustrating a coordinate reading step S10 using a first positioning member 10 and a second positioning member 20 on both of which scales are marked. FIG. 20 illustrates a case where an embedding hole 54 is directly formed in the mockup 41. FIG. 21 is an enlarged view of a tooth 45 for which wax-up is performed. FIG. 22 illustrates cut-and-try.

As shown in FIG. 16, a bone 62 composed of a soft cancellous bone 60 and a hard cortex bone 61, and a mucosa 63 that covers the bone 62 remain at the portion a tooth (not shown) is missing. The implant 70 includes a fixture 71 embedded into an embedding hole (guide hole) formed in the bone 62, an abutment 72 coupled to the fixture 71 and serving as a support, and a superstructure (artificial tooth crown) 73 attached to the abutment 72.

As shown in FIG. 1 and FIG. 2, the stent S includes a guide member 1, a first positioning member 10, a second positioning member 20, and a CT scanner positioning reference plate 30.

The guide member 1 has a fitting portion 2 bent into a roughly “U” shape, and a covering portion 3 extending from one tip portion of the fitting portion 2. The fitting portion 2 is formed such that it fits with a tooth portion 42 of an upper jaw mockup 40 (plaster model for the upper jaw) (see FIG. 5) or with a tooth portion 43 of a lower jaw mockup 41 (plaster model for the lower jaw). The mockups are made by impression (molding) of the inside of the mouth of the patient. In the example shown in FIG. 1 and FIG. 2, the fitting portion 2 is formed such that it fits with the tooth portion 43 of the lower jaw mockup 41. In addition, the fitting portion 2 is formed such that it fits also with the actual tooth portion (not shown) of the patient that corresponds to the tooth portion 43 of the lower jaw mockup 41. The fitting portion 2 is detachably attachable to the tooth portion 43 of the mockup 41 and to the tooth portion of the patient that corresponds to the tooth portion 43 of the mockup 41. The covering portion 3 of the guide member 1 is formed such that it adheres to and covers a mucosa surface 44 at a portion the tooth is missing. Wax-up is performed for teeth 45 described later (see FIG. 6) onto a surface (upper surface) of the mucosa surface 44 of the mockup 41. On the back surface (lower surface) 3b of the covering portion 3, i.e., the portion that contacts the mucosa surface 44, a sheet-like (curved) third contrast medium 4 is provided. The third contrast medium 4 is used for calculating the thickness of the mucosa by measuring the distance from the bone to the third contrast medium 4, on a CT scanner display described later. Instead of providing the third contrast medium 4, the thickness of the mucosa can be calculated on the CT scanner display by subtracting the distance measured from the back surface (lower surface) 3b of the covering portion 3 to a first contrast medium 11 (described later), from the distance measured from the bone to the first contrast medium 11.

The first positioning member 10 includes at least a planar first contrast medium 11 for a CT scanner. In this embodiment, the first positioning member 10 is made of a resin that contains a contrast medium, and formed into a rectangular plate-like shape. In other words, a surface (upper surface) of the first positioning member 10 serves as the first contrast medium 11. The first positioning member 10 may have a thickness of, for example, about 1 to 2 mm, and fixed to a flat surface 3c formed on a surface (upper surface) 3a of the covering portion 3 of the above-mentioned guide member 1. The flat surface 3c is parallel to an occlusal flat surface H (a flat surface that serves as a reference of the occlusion between the teeth in the upper jaw and the teeth in the lower jaw) (see FIG. 5). As shown in FIG. 3, engaging holes 12 and 13 are formed on both sides of a line L1 that bisects the first positioning member 10. Tip portions of spacers 26 and 27 described later (see FIG. 3) of the second positioning member 20 are engaged and disengaged with the engaging holes 12 and 13. First positioning references 14 and 15 are formed at the portions that correspond to the two engaging holes 12 and 13 by removing the contrast medium. However, the first positioning references 14 and 15 are not necessarily formed at those positions. The first positioning member 10 is fixed to the surface (upper surface) 3a of the covering portion 3 of the above-mentioned guide member 1, with the two engaging holes 12 and 13 being faced upward. In this embodiment, the entire planar first positioning member 10 includes the contrast medium. However, instead of this example, a planar (sheet-like) first contrast medium 11 may be provided only to a surface (the surface opposite to the surface that is fixed to the covering portion 3) of a rectangular first positioning member 10.

The second positioning member 20 is made of a resin that contains a contrast medium, and formed into a rectangular plate-like shape that is roughly a same shape as the above-mentioned first positioning member 10, and disposed in substantially parallel to the above-mentioned first positioning member 10. Fitting holes 22 and 23 are formed in the second positioning member 20 at the portions that correspond to the engaging holes 12 and 13 in the above-mentioned first positioning member 10. In other words, cylindrical two fitting holes 22 and 23 are formed on both sides of a line L2 that bisects the second positioning member 20. Base end portions of the two cylindrical spacers 26 and 27 are fitted and fixed to the two fitting holes 22 and 23. Tip potions of the two spacers 26 and 27 can be engaged or disengaged with the engaging holes 12 and 13 of the above-mentioned first positioning member 10. In other words, the second positioning member 20 and the two spacers 26 and 27 are formed integrally, and the second positioning member 20 can be engaged or disengaged with the first positioning member 10 via the two spacers 26 and 27. When the second positioning member 20 is engaged with the first positioning member 10, both of the positioning members 10 and 20 are spaced apart by a predetermined gap (for example, about 8 to 12 mm), and disposed in substantially parallel to each other. Second positioning references 24 and 25 are formed in the second positioning member 20 by removing the portions of the contrast medium that correspond to the two fitting holes 22 and 23. However, the second positioning references 24 and 25 are not necessarily formed at those positions. In this embodiment, the entire planar second positioning member 20 includes the contrast medium. Alternatively, a planar (sheet-like) second contrast medium 21 may be provided only on a surface of a rectangular second positioning member (the surface opposite to the first positioning member 10), for example. The positions of the engaging holes 12 and 13 with which the two spacers 26 and 27 are engaged or disengaged are not necessarily limited to the positions described above. Alternatively, for example, these position may be the positions on the first positioning member 10 that correspond to near the midpoints of two, right and left, shorter sides 10a of the first positioning member 10 and the positions near the midpoints of two, right and left, shorter sides 20a of the second positioning member 20; or the positions on the first positioning member 10 that correspond to near two opposing corners of the first positioning member 10 and near two opposing corners of the second positioning member 20. These approaches will increase the area of the portions of the first contrast medium 11 and the second contrast medium 21 that can be effectively used. Furthermore, contrary to the example described above, the two spacers 26 and 27 may be integrally formed with the first positioning member 10.

As shown in FIG. 1 and FIG. 2, the CT scanner positioning reference plate 30 is mounted to the front side (the portion that corresponds to foreteeth) in the above-mentioned guide member 1. The CT scanner positioning reference plate 30 is disposed in substantially parallel to the first positioning member 10 and the second positioning member 20 described above, i.e., in substantially parallel to the occlusal flat surface H. A portion 31 that corresponds to the lip is formed into an arrow shape, and a protruding portion 32 that protrudes from the mouth is formed into a rectangular plate-like shape. The protruding portion 32 may be an arc-shape, instead of the rectangular shape. When the guide member 1 of the stent S is fitted to the tooth portion of the patient, the above-mentioned plate-like protruding portion 32 of the CT scanner positioning reference plate 30 protrudes outside of the mouth. A CT-scan operator performs CT scanning in which the guide member 1 of the stent S is fitted to the tooth portion of the patient and a positioning line laser beam of a CT scanner apparatus is directed to a side surface of the protruding portion 32 protruding from the mouth. This makes each of the flat surfaces of the first contrast medium 11 of the first positioning member 10 and the second contrast medium 21 of the second positioning member 20 described above be disposed in substantially parallel to CT cross-sections. Therefore, both of the first contrast medium 11 and the second contrast medium 21 are projected in flat shapes onto the CT scanner display, and the CT cross-sections become in substantially parallel to the occlusal flat surface 3c. This fact is advantageous in the simulation step S7, the modifying step S8, the intersection point determining step S9, and the coordinate reading step S10, described later.

A method for positioning the wire W (see FIG. 15) using the stent S having a configuration described above is described. The wire W is used for indicating on the mockup 41 the position and orientation of the fixture 71 (see FIG. 16) of the implant 70 to be embedded at. A surgical guide will be created based on the wire. In other words, the position and orientation of the wire W embedded in the mockup 41 reproduce the position and orientation the fixture 71 is to be embedded in the actual mouth of the patient. Therefore, it is required that the wire W should be embedded in the mockup 41 at an anatomically and prosthetically appropriate position and orientation with high accuracy. A method for positioning the wire W with high accuracy is described in detail hereinafter.

As shown in FIG. 4, the method for positioning the wire W includes the steps of:

(1) a wax-up hole forming step S1,

(2) an irradiating step S2,

(3) a positioning reference forming step S3,

(4) a second positioning step S4,

(5) a first positioning step S5,

(6) an imaging step S6,

(7) a simulation step S7,

(8) a modifying step S8,

(9) an intersection point determining step S9,

(10) a coordinate reading step S10,

(11) a drawing step S11,

(12) a marking step S12,

(13) a second through-hole forming step S13,

(14) a pointer positioning step S14,

(15) an embedding hole forming step S15, and

(16) an embedding step S16.

The steps are described hereinafter step by step.

The wax-up hole forming step S1 of (1) is a step in which the upper jaw mockup 40 and the lower jaw mockup 41 are mounted to an articulator 50, and wax-up is performed for missing teeth 45 onto a surface (upper surface) of the mucosa surface 44, and first through-holes 45a are formed at the position and orientation the fixture 71 is to be embedded, in the teeth 45 for which wax-up is performed, as shown in FIG. 5, FIG. 6, and FIG. 7. At first, wax-up is performed for the teeth 45 into a shape and at a position that are prosthetically appropriate based on the occlusion between the upper jaw mockup 40 and the lower jaw mockup 41, or other factors. After that, the first through-holes 45a are formed at the position and orientation of the abutment 72 that are appropriate for the teeth 45 for which wax-up is performed, i.e., for example, as shown in FIG. 7A, from substantially center of the occlusal surface (the surface as seen from above) of the teeth 45 and along the orientation of the tooth axis of the teeth 45, without considering the internal structure (anatomical shape) of the jaw bone of the patient. The position and orientation of the central axis C (see FIG. 21) of the first through-hole 45a become the position and orientation that are prosthetically appropriate for the fixture 71 to be embedded at. The diameter of the first through-hole 45a is made substantially same as the diameter of the fixture 71. FIG. 7B illustrates a vertical cross sectional view of the teeth 45.

The irradiating step S2 of (2) is a step in which the center of the first through-hole 45a in the tooth 45 is irradiated by a light beam L emitted from the pointer 52 movably supported by a supporting member 51, as shown in FIG. 8. The supporting member 51 has a base end portion 51a being mounted to the mockup 41. At first, a mark 44a is marked at the position that corresponds to the center of the first through-hole 45a in the tooth 45 onto the mucosa surface 44 of the mockup 41, i.e., the point at which the central axis C of the first through-hole 45a intersects the mucosa surface 44 (see FIG. 21). After that, the position and orientation of the pointer 52 are adjusted such that the light beam L from the pointer 52 passes through the center of the first through-hole 45a, and irradiates the mark 44a. The pointer 52 is fixed by the supporting member 51 at that position and orientation. In other words, the optical axis of the light beam L and the central axis C of the first through-hole 45 are aligned with each other. At this moment, the position and orientation of the light beam L become the position and orientation that are prosthetically appropriate for the fixture 71 to be embedded at. The supporting member 51 may be formed of, for example, thick wires or metal rods coupled with joints. The supporting member 51 is configured such that the position and orientation of the pointer 52 may be readily modified manually, and the position and orientation of the pointer 52 may be retained by fixing the pointer 52. As shown in FIG. 18, the surveyor 80, which is used in dental laboratory, may be used as the supporting member 51. In this case, the pointer 52 is mounted to a tool retaining portion 81 of the surveyor 80, and the mockup 41 is mounted to a mockup table 82. The position of the pointer 52 is movable forward, backward, rightward, and leftward as desired, and the orientation (inclination) of the mockup 41 can be modified as desired. The position and orientation (inclination) of the pointer 52 and the mockup 41 can be maintained by fixing them. Alternatively, there is a surveyor 80 having a tool retaining portion 81 being fixed thereto and a mockup table 82 being movable forward, backward, rightward, and leftward as desired. The use of a laser-type pointer for the pointer 52 may be convenient.

The positioning reference forming step S3 of (3) is a step in which the first positioning references 14 and 15 (see FIG. 3) are formed by removing a portion of the first contrast medium 11, and the second positioning references 24 and 25 are formed by removing a portion of the second contrast medium 21. The first positioning references 14 and 15 are formed at the two positions described above in the first contrast medium 11, and the second positioning references 24 and 25 are formed at the two positions described above in the second contrast medium 21. However, the first positioning references 14 and 15 and the second positioning references 24 and 25 are not necessarily formed at those positions. In this embodiment, this step can be omitted because the first positioning references 14 and 15 are previously formed at two positions in the first contrast medium 11 of the first positioning member 10, and the second positioning references 24 and 25 are previously formed at two positions in the second contrast medium 21 of the second positioning member 20, as shown in FIG. 3.

The second positioning step S4 of (4) is a step in which the teeth 45 for which wax-up is performed shown in FIG. 8 are removed from the mockup 41, and the stent S is mounted to the mockup 41 instead, and a second removed portion 20c is formed by removing a portion, which is irradiated by the light beam L, of the second contrast medium 21 in the second positioning member 20 of the stent S, as shown in FIG. 9. More specifically, at first, the fitting portion 2 of the guide member 1 of the stent S is fitted to the tooth portion 43 of the mockup 41 such that the covering portion 3 covers the mucosa surface 44 at the portion the teeth are missing. At this moment, the first positioning member 10 is located above the mucosa surface 44, and the second positioning member 20 is located, spaced apart by a predetermined gap, above the first positioning member 10. In other words, the first contrast medium 11 and the second contrast medium 21 are disposed in substantially parallel to each other. The third contrast medium 4 provided on the back surface 3b of the covering portion 3 adheres to the mucosa surface 44. The second removed portion 20c is formed by removing a portion, which is irradiated by the light beam L, of the second contrast medium 21 in the second positioning member 20 of the stent S. There are two ways, a first method (A) and a second method (B), for forming the second removed portion 20c. In the first method (A), a second through-hole 20b is formed at the portion irradiated by the light beam L, in the second positioning member 20, as shown in FIG. 9. In the second method (B), a concave portion is formed without forming the second through-hole 20b, and the second contrast medium 21 at the portion of the concave portion is removed.

When the second contrast medium 21 is projected in a flat shape onto the CT scanner display in the simulation step S7 described later, the second removed portion 20c formed in the second positioning step S4, and the two second positioning references 24 and 25 described above are projected as portions at which the contrast medium is missing.

The first positioning step S5 of (5) is a step for forming a first removed portion 10c by removing a portion, which is irradiated by the light beam L, of the first contrast medium 11 in the first positioning member 10, as shown in FIG. 9. In this step, in a case where the first method (A) of the above-mentioned second positioning step S4 is adopted, a concave portion 10b is formed at the portion irradiated by the light beam L that passes through the second through-hole 20b of the above-mentioned second positioning member 20, and the first contrast medium 11 at that portion is removed to form the first removed portion 10c. On the other hand, in a case where the second method (B) is adopted, the second positioning member 20 is disengaged, and the concave portion 10b is formed at the portion irradiated by the light beam L in that condition, and the first contrast medium 11 at the concave portion 10b is removed to form the first removed portion 10c. When the first contrast medium 11 is projected in a flat shape onto the CT scanner display in the simulation step S7 described later, the first removed portion 10c formed in first positioning step S5, and the two first positioning references 14 and 15 described above are projected as portions at which the contrast medium is missing. If the second removed portion 20c and the first removed portion 10c are coupled with, for example, an aluminum wire or a string containing a contrast medium, a line that connects the two removed portions 20c and 10c will be projected onto the CT scanner display in the simulation step S7 described later, which will ease the simulating operation.

The imaging step S6 of (6) is a step in which the stent S is removed from the mockup 41, and fitted to the tooth portion of the patient and CT scanning is performed. The CT scanning is performed such that a positioning line laser beam of a CT scanner apparatus is directed to a side surface of the CT scanner positioning reference plate 30 that protrudes from the mouth of the patient. This makes each of the flat surfaces of the first contrast medium 11 and the second contrast medium 21 be disposed in substantially parallel to CT cross-sections. The CT scanning is performed each in X, Y, and Z directions every 0.5 to 1.0 mm, and data is obtained. For the CT scanner apparatus, instead of a conventional helical-scan type apparatus, a cone-beam type apparatus may be used for obtaining a clearer image with higher-resolution.

The simulation step S7 of (7) is a step for simulating on the CT scanner display a virtual embedding hole 53, into which the fixture 71 is to be embedded, in the bone 62 along an extended line of a straight line L3 that connects the first removed portion 10c and the second removed portion 20c, as shown in FIG. 10. By this simulation, the relation between the internal structure (anatomical shape) of the jaw bone of the patient and the virtual embedding hole 53 can be comprehended. In other words, the position and orientation of the virtual embedding hole 53 that are prosthetically appropriate can be analyzed from an anatomical point of view. If the position and orientation of the virtual embedding hole 53 are appropriate also from the anatomical point of view, these position and orientation, in other words, the position and orientation of the central axis C of the first through hole 45a in the tooth 45 for which wax-up is performed, may be determined as the position and orientation of the embedding hole 54 into which the fixture 71 is to be embedded. Therefore, in such a case, at first, the tooth 45 for which wax-up is performed is mounted to the mockup 41, and a tip 57a of a drill 57 is tapped on the mark 44a, and the axis of the drill 57 is aligned with the central axis C of the first through-hole 45a, and then the drilling operation is performed to form the embedding hole 54 directly in the mockup 41 (see FIG. 20 and FIG. 21). By these operations, the steps from the modifying step S8 to the embedding hole forming step S15, described hereinafter may be skipped over to the embedding step S16.

The modifying step S8 of (8) is a step for modifying the position and orientation of the virtual embedding hole 53 on the CT scanner display, based on the internal structure of the jaw bone of the patient. The virtual embedding hole determined by the modification becomes a virtual embedding hole 53A as shown in FIG. 12A.

The intersection point determining step S9 of (9) is a step for obtaining on the CT scanner display a first intersection point P1 and a second intersection point P2, which are the points at which the center line L4 of the modified virtual embedding hole 53A of the fixture 71 intersects the first contrast medium 11 and the second contrast medium 21, as shown in FIG. 12A.

The coordinate reading step S10 of (10) is a step for reading on the CT scanner display the coordinate of the first intersection point P1 with respect to the first positioning references 14 and 15 and the coordinate of the second intersection point P2 with respect to the second positioning references 24 and 25, as shown in FIG. 12B. For example, a distance D1 from the center of the first positioning reference 14 in the first contrast medium 11 to the first intersection point P1 is read from the scales on the x-axis or y-axis using a divider on the display. Similarly, a distance D2 from the center of the first positioning reference 15 to the first intersection point P1 is read. Further similarly, a distance D3 from the center of the second positioning reference 24 in the second contrast medium 21 to the second intersection point P2 is read, and a distance D4 from the center of the second positioning reference 25 to the second intersection point P2 is read.

The drawing step S11 of (11) is a step for drawing the first intersection point P1 and the second intersection point P2 onto the first contrast medium 11 and the second contrast medium 21 of the stent S, based on the read coordinate, as shown in FIG. 12C. An arc having a radius of the distance D1 is drawn with a compass centered at the center of first positioning reference 14 on the first contrast medium 11. In addition, an arc having a radius of the distance D2 is drawn with the compass centered at the center of the first positioning reference 15. The intersection point of these arcs becomes the first intersection point P1. Similarly, an arc having a radius of the distance D3 is drawn with the compass centered at the second positioning reference 24 on the second contrast medium 21. In addition, an arc having a radius of the distance D4 is drawn with the compass centered at the center of the second positioning references 25. The intersection point of these arcs becomes the second intersection point P2.

The marking step S12 of (12) is a step for putting a mark 18 shown in FIG. 12C at the first intersection point P1 drawn on the first contrast medium 11.

The second through-hole forming step S13 of (13) is a step for forming a second through-hole 28 at the second intersection point P2 drawn on the second contrast medium 21. In this step, a mark, instead of the second through-hole 28 to be formed, may be put thereon.

The pointer positioning step S14 of (14) is a step in which the stent S is mounted to the mockup 41, and the pointer 52 is fixed to the mounted stent S at such position and orientation that the light beam L from the pointer 52 passes through the second through-hole 28 and irradiates the mark 18, as shown in FIG. 13. At first, the second positioning member 20 is engaged with the first positioning member 10 via the two spacers 26 and 27, and the stent S is mounted to the tooth portion 43 of the mockup 41. After that, the position and orientation of the pointer 52 are adjusted such that the light beam L from the pointer 52 passes through the center of the second through-hole 28, and irradiates the mark 18, and the pointer 52 is fixed to the adjusted position and orientation using the supporting member 51. In a case where the mark is put, instead of the second through-hole 28 being formed, in the above-mentioned second through-hole forming step S13, fine adjustments of the position and orientation of the pointer 52 are made until the light beam L from the pointer 52 irradiates both of the mark and the mark 18 on the first contrast medium 11 by repeating the engagement and disengagement of the second positioning member 20. After the adjustments are made, the pointer 52 is fixed with the supporting member 51. At this moment, the position and orientation of the light beam L are aligned with the position and orientation of the center line L4 of the virtual embedding hole 53A on the CT scanner display. Therefore, the position and orientation of the virtual embedding hole 53A modified from the anatomical view can be analyzed from a prosthetic point of view if the stent S is removed from the mockup 41 and the tooth 45 for which wax-up is performed is mounted to the mockup 41, and the position and orientation of the central axis C of the first through-hole 45a in the tooth 45 and the position and orientation of the light beam L are compared, and if necessary, the tooth 45 is moved to such a position that the central axis C of the first through-hole 45a is aligned with the light beam L, and the mockup 41 is mounted back to the articulator 50 so that occlusal relation and mesiodistal and buccolingual position and orientation of the dental antagonist of the moved tooth 45 are three-dimensionally comprehended.

The embedding hole forming step S15 of (15) is a step in which the stent S is removed from the mockup 41, and an embedding hole 54 is formed in the mockup 41 along the optical axis of the light beam L from the pointer 52, as shown in FIG. 14. The tip 57a of the drill 57 mounted to a contra head 56 is tapped onto the portion irradiated by the light beam L in the mockup 41, and the orientation of the drill 57 is adjusted such that the light beam L impinges at the center of a circular portion 57b of the base end portion of drill 57, and drilling operation is performed to form the embedding hole 54.

The embedding step S16 of (16) is a step in which the wire W is embedded in the embedding hole 54, as shown in FIG. 15. A tube 55 is inserted in the embedding hole 54 and fixed with an adhesive or the like, and the wire W is embedded therein by inserting the wire W in the tube 55.

FIG. 17 is a flowchart illustrating steps from the (1) wax-up hole forming step S1 to the (16) embedding step S16 described above. By performing the steps from S1 to S14 among the steps described above, the position and orientation that are prosthetically appropriate for the fixture 71 to be embedded at determined on the mockup 41 that is mounted to the articulator 50 (see FIG. 5 and FIG. 6) are modified on the CT scanner display after analyzed from the anatomical point of view (after the simulation step S7 shown in FIG. 17). The modified position and orientation of the fixture 71 to be embedded at can be reproduced again on the mockup 41 as the position and orientation of the light beam L from the pointer 52. Therefore, the modified position and orientation of the fixture 71 analyzed from the anatomical point of view can be analyzed again from the prosthetic point of view by comparing on the mockup 41 the position and orientation of the light beam L and the position and orientation of the teeth 45 for which wax-up is performed, and if necessary, by mounting the mockup 41 back to the articulator 50 after moving the teeth 45 for which wax-up is performed to a position and orientation same as the position and orientation of the light beam L. As a result of such analyses, in some cases, after returning to the (8) modifying step S8 to modify again the position and orientation of the virtual embedding hole 53A, the position and orientation that are anatomically and prosthetically appropriate for the fixture 71 to be embedded at can be determined only after cut-and-try processes are repeated between the (8) modifying step S8 and the (14) pointer positioning step S14. The wire W is embedded at the position and orientation of the fixture 71 that are finally determined as described above, in the (15) embedding hole forming step S15 and the (16) embedding step S16. A surgical guide will be created based on the wire W.

In the example described above, the wire W is embedded in the lower jaw mockup 41; however, the wire W to be embedded in the upper jaw mockup 40 is similar to that descried above, excepting that the orientation is turned upside down.

By performing the steps from the (1) wax-up hole forming step S1 to the (7) simulation step S7 among the steps of (1) to (16) described above using the above-mentioned stent S, the position and orientation of the fixture 71 to be embedded at on the mockup 41 can be reproduced on the CT scanner display readily and with high accuracy.

In addition, by performing from the (8) modifying step S8 to the (14) pointer positioning step S14 among the steps of (1) to (16) described above using the above-mentioned stent S, the position and orientation of the fixture 71 to be embedded at on the CT scanner display can be reproduced on the mockup 41 readily and with high accuracy.

Instead of the first contrast medium 11 and the second contrast medium 21, or the first positioning member 10 and the second positioning member 20 described above, a plate of aluminum or titanium can be used. In this case, for example, if grid-like scales are marked by 1 mm vertically and laterally (in x direction and y direction) on the plate as shown in FIG. 19 such that the scales are projected on the CT scanner display, the coordinate (x1, y1) of the first intersection point P1 and the coordinate (x2, y2) of the second intersection point P2 can be directly read on the CT scanner display in the above-mentioned coordinate reading step S10, as shown in FIG. 19. By this operation, the positioning reference forming step S3 and the drawing step S11 can be omitted and the coordinate reading step S10 can be simplified.

In this case, the position and orientation of the center line L4 of the virtual embedding hole 53 of the fixture on the CT scanner display and the position and orientation of the light beam L from the pointer 52 on the mockup 41 are determined only by the two coordinates of the first intersection point P1 and the second intersection point P2, and these coordinates are directly read, and thus the anatomical analysis and the prosthetic analysis can be performed substantially simultaneously. Therefore, cut-and-try can be readily performed (see FIG. 22) by adding slight modifications while observing both of the centerline L4 on the CT scanner display and the teeth 45 on the mockup 41 and the light beam L. As a result, the position and orientation that are anatomically and prosthetically appropriate for the fixture to be embedded at can be readily found out. In addition, it is also possible to determine the prosthetically appropriate position and orientation to be embedded at after CT scanning.

A similar effect can be obtained even in a case where the first contrast medium 11 and the second contrast medium 21 are used, if scales similar to those of described above are marked thereon, and the contrast medium at the portions of the scales is removed. Alternatively, a similar effect can be obtained in a case where the first contrast medium 11 and the second contrast medium 21 are used, if small holes are provided at the positions that correspond to the points at which a plurality of vertical scales intersect a plurality of lateral scales, i.e., a multiple of small holes are arrayed vertically and laterally, and the contrast medium at portions of these small holes is removed. In this case, these multiple of small holes serve as scales.

In addition, other than these examples, a similar effect can be obtained by using a resin having grooves that serve as grid-like scales in which contrast medium is filled, or a punching metal or a grid-like wire gauze of aluminum or titanium, or a resin on which a grid-like metal gauze is pasted or embedded therein.

If grid-like scales are marked on the third contrast medium 4 and the contrast medium at the portions of the scales is removed, or a grid-like wire gauze of aluminum is embedded into the back surface (lower surface) 3b of the covering portion 3 along its curve instead of providing the third contrast medium 4, the position the fixture 71 is to be embedded at into the mucosa surface 44 on the CT scanner display and on the mockup 41, i.e., the position at which the center line L4 of the virtual embedding hole 53 and the light beam L from the pointer 52 (or the wire W) intersect the mucosa surface 44, can be readily observed.

In the embodiment described above, the first contrast medium 11 and the second contrast medium 21 are disposed in parallel to each other; however, these are not necessarily to be in parallel. The first contrast medium 11 and the second contrast medium 21 are used for determining two points in three dimensions in order to determine the position and orientation that are anatomically and prosthetically appropriate for the fixture 71 to be embedded at. Therefore, even if these contrast mediums are not in parallel to each other, the two points in three dimensions described above can be determined through operations on the display of a CT scanner apparatus.

If an X-ray absorber is mixed in the fitting portion 2 of the guide member 1, or applied to or pasted on the surface (upper surface) thereof, the X-ray reflection from a metal crown during CT scanning can be inhibited and halation can be reduced. By this operation, a clear CT image with minimum halation can be obtained. Examples of the X-ray absorber include barium sulfate powder, lead foil or powder, an iodine additive, or the like.
1 guide member
2 fitting portion
3 covering portion
4 third contrast medium
40 upper jaw mockup (plaster model for the upper jaw)
41 lower jaw mockup (plaster model for the lower jaw)
70 implant (dental implantation)
10 first positioning member
11 first contrast medium
12, 13 engaging hole
14, 15 first positioning reference (first removed portion)
20 second positioning member
21 second contrast medium
24, 25 second positioning reference (second removed portion)
26, 27 spacer
30 CT scanner positioning reference plate
45 tooth for which wax-up is performed
50 articulator
51 supporting member
52 pointer
S1 wax-up hole forming step
S2 irradiating step
S3 positioning reference forming step
S4 second positioning step
S5 first positioning step
S5 Imaging step
S7 simulation step
S8 modifying step
S9 intersection point determining step
S10 coordinate reading step
S11 drawing step
S12 marking step
S13 second through-hole forming step
S14 pointer positioning step
S15 embedding hole forming step
S16 embedding step
C central axis of the first through-hole 45a in the teeth 45
H occlusal flat surface
W wire

1. A stent used for positioning a wire that indicates the position and orientation a dental implant fixture is to be embedded at when the wire is embedded in an upper jaw mockup or a lower jaw mockup, the mockup imitating inside of the mouth of a patient, the stent comprising:
a detachably attachable guide member that includes a fitting portion to be fitted to a tooth portion of the mockup and to an actual tooth portion of the patient that corresponds to the tooth portion of the mockup, and a covering portion that covers a mucosa surface at a portion a tooth is missing;
a first positioning member including at least a planar first contrast medium for a CT scanner and mounted to the covering portion; and
a second positioning member including at least a planar second contrast medium for the CT scanner, the second positioning member opposing to the first contrast medium and being detachably attachable to the first positioning member.

2. The stent according to claim 1 characterized in that the first contrast medium and the second contrast medium are disposed in substantially parallel to each other.

3. The stent according to claim 1, comprising:
first positioning references formed by removing a portion of the first contrast medium, and
second positioning references formed by removing a portion of the second contrast medium.

4. The stent according to claim 3 characterized in that:
the second positioning member includes two pole-like spacers embedded therein facing toward the first positioning member, and
the first positioning member includes engaging holes with which the tip of the spacers are engaged, and
the second positioning references are formed at portions corresponding to base end portions of the two spacers, and
the first positioning references are formed at portions corresponding to the engaging holes.

5. The stent according to claim 1 characterized in that a planar third contrast medium is provided in the covering portion of the guide member at a portion that contacts the mucosa surface.

6. The stent according to claim 2 characterized in that the stent comprises a planar reference plate for positioning a CT scanner, the reference plate being mounted to the guide member in substantially parallel to the first contrast medium and the second contrast medium, and protruding outward from the mouth of the patient when the guide member is fitted to the tooth portion of the patient.

7. The stent according to claim 1 characterized in that an X-ray absorber is provided in the fitting portion of the guide member or on a surface of the fitting portion.

8. The stent according to claim 1 characterized in that grid-like scales are provided to the first contrast medium and the second contrast medium, and the contrast medium at the portions of the scales is removed.

9. The stent according to claim 1 characterized in that a multiple of small holes are provided in a grid-like pattern to the first contrast medium and the second contrast medium, and the contrast medium at the portions of the small holes is removed.

10. A method for reproducing on a CT scanner display the position and orientation of a fixture to be embedded at on a mockup that imitates inside of the mouth of a patient, the method using a stent that includes a detachably attachable guide member that includes a fitting portion to be fitted to a tooth portion of the mockup and to an actual tooth portion of the patient that corresponds to the tooth portion of the mockup, and a covering portion that covers a mucosa surface at a portion a tooth is missing; a first positioning member including at least a planar first contrast medium for a CT scanner and mounted to the covering portion; and a second positioning member including at least a planar second contrast medium for the CT scanner, the second positioning member opposing to the first contrast medium and being detachably attachable to the first positioning member, the method comprising:
(1) a wax-up hole forming step in which an upper jaw mockup and a lower jaw mockup are mounted to an articulator, and wax-up for the missing tooth is performed on the mucosa surface of the mockup, and a first through-hole is formed at the position and orientation the fixture should be embedded, in the tooth for which wax-up is performed,
(2) an irradiating step for irradiating the center of the first through-hole by a light beam from a pointer movably supported by a supporting member, a base end portion of the supporting member being mounted to the mockup,
(3) a positioning reference forming step for forming first positioning references by removing a portion of the first contrast medium, and forming second positioning references by removing a portion of the second contrast medium,
(4) a second positioning step in which the tooth for which wax-up is performed is removed from the mockup, and the stent is mounted to the mockup, and a second removed portion is formed by removing a portion, which is irradiated by the light beam, of the second contrast medium in the second positioning member of the stent,
(5) a first positioning step for forming a first removed portion by removing a portion, which is irradiated by the light beam, of the first contrast medium in the first positioning member,
(6) an imaging step in which the stent is removed from the mockup, and the stent is fitted to the tooth portion of the patient and CT scanning is performed, and
(7) a simulation step for simulating on the CT scanner display a virtual embedding hole of the fixture, along an extended line of a straight line that connects the first removed portion and the second removed portion.

11. A reproducing method for reproducing on a mockup the position and orientation of a fixture to be embedded at on a CT scanner display, the mockup imitating inside of the mouth of a patient, the method using a stent that includes a detachably attachable guide member that includes a fitting portion to be fitted to a tooth portion of the mockup and to an actual tooth portion of the patient that corresponds to the tooth portion of the mockup, and a covering portion that covers a mucosa surface at a portion a tooth is missing; a first positioning member including at least a planar first contrast medium for a CT scanner and mounted to the covering portion; and a second positioning member including at least a planar second contrast medium for the CT scanner, the second positioning member opposing to the first contrast medium and being detachably attachable to the first positioning member, the reproducing method comprising:
(8) a modifying step for modifying a virtual embedding hole on the CT scanner display, based on the internal structure of the jaw bone of the patient,
(9) an intersection point determining step for obtaining a first intersection point and a second intersection point on the display, the intersection points being the points at which the center line of the modified virtual embedding hole of the fixture intersects the first contrast medium and the second contrast medium,
(10) a coordinate reading step for reading on the display the coordinate of the first intersection point with respect to the first positioning references and the coordinate of the second intersection point with respect to the second positioning references,
(11) a drawing step for drawing the first intersection point and the second intersection point onto the first contrast medium and the second contrast medium of the stent, based on the read coordinates,
(12) a marking step for putting a mark at the first intersection point drawn on the first contrast medium,
(13) a second through-hole forming step for forming a second through-hole at the second intersection point drawn on the second contrast medium, and
(14) a pointer positioning step in which the stent is mounted to the mockup, and a pointer is fixed to the mounted stent at a position such that the light beam from the pointer, which passes through the second through-hole, irradiates the mark.

12. A positioning method for positioning a wire that indicates the position and orientation a dental implant fixture is to be embedded at when the wire is embedded in the mockup, the method using a stent that includes a detachably attachable guide member that includes a fitting portion to be fitted to a tooth portion of a mockup that imitates inside of the mouth of a patient and to an actual tooth portion of the patient that corresponds to the tooth portion of the mockup, and a covering portion that covers a mucosa surface at a portion a tooth is missing; a first positioning member including at least a planar first contrast medium for a CT scanner and mounted to the covering portion; and a second positioning member including at least a planar second contrast medium for the CT scanner, the second positioning member opposing to the first contrast medium and being detachably attachable to the first positioning member, the positioning method comprising:
(1) a wax-up hole forming step in which an upper jaw mockup and a lower jaw mockup are mounted to an articulator, and wax-up for the missing tooth is performed on the mucosa surface of the mockup, and a first through-hole is formed at the position and orientation the fixture should be embedded, in the tooth for which wax-up is performed,
(2) an irradiating step for irradiating the center of the first through-hole by a light beam from a pointer movably supported by a supporting member, a base end portion of the supporting member being mounted to the mockup,
(3) a positioning reference forming step for forming first positioning references by removing a portion of the first contrast medium, and forming second positioning references by removing a portion of the second contrast medium,
(4) a second positioning step in which the tooth for which wax-up is performed is removed from the mockup, and the stent is mounted to the mockup, and a second removed portion is formed by removing a portion, which is irradiated by the light beam, of the second contrast medium in the second positioning member of the stent,
(5) a first positioning step for forming a first removed portion by removing a portion, which is irradiated by the light beam, of the first contrast medium in the first positioning member,
(6) an imaging step in which the stent is removed from the mockup, and the stent is fitted to the tooth portion of the patient and CT scanning is performed,
(7) a simulation step for simulating on the CT scanner display a virtual embedding hole of the fixture, along an extended line of a straight line that connects the first removed portion and the second removed portion,
(8) a modifying step for modifying the virtual embedding hole on the CT scanner display, based on the internal structure of the jaw bone of the patient,
(9) an intersection point determining step for obtaining a first intersection point and a second intersection point on the display, the first and second intersection points being the points at which the center line of the modified virtual embedding hole of the fixture intersects the first contrast medium and the second contrast medium,
(10) a coordinate reading step for reading on the display the coordinate of the first intersection point with respect to the first positioning references and the coordinate of the second intersection point with respect to the second positioning references,
(11) a drawing step for drawing the first intersection point and the second intersection point onto the first contrast medium and the second contrast medium of the stent, based on the read coordinates,
(12) a marking step for putting a mark at the first intersection point drawn on the first contrast medium,
(13) a second through-hole forming step for forming a second through-hole at the second intersection point drawn on the second contrast medium,
(14) a pointer positioning step in which the stent is mounted to the mockup, and a pointer is fixed to the mounted stent at a position such that the light beam from the pointer, which passes through the second through-hole, irradiates the mark,
(15) an embedding hole forming step in which the stent is removed, and an embedding hole is formed in the mockup, along the light beam from the pointer, and
(16) an embedding step in which a wire is embedded in the embedding hole.
